(19) United States
(12) Patent Application Publication
(10) Pub. No.: US 2026/0317918 A1
(43) Pub. Date: Oct. 15, 2026

(54) MEMBRANE ELECTRODE ASSEMBLY, ELECTROCHEMICAL CELL, AND HYDROGEN PRODUCTION DEVICE

(71) Applicants: KABUSHIKI KAISHA TOSHIBA, Kawasaki-shi Kanagawa (JP); TOSHIBA ENERGY SYSTEMS & SOLUTIONS CORPORATION, Kawasaki-shi Kanagawa (JP)

(72) Inventors: Taishi FUKAZAWA, Chofu Tokyo (JP); Norihiro YOSHINAGA, Yokohama Kanagawa (JP); Akihiko ONO, Kita Tokyo (JP); Yoshitsune SUGANO, Kawasaki Kanagawa (JP)

(73) Assignees: KABUSHIKI KAISHA TOSHIBA, Kawasaki-shi Kanagawa (JP); TOSHIBA ENERGY SYSTEMS & SOLUTIONS CORPORATION, Kawasaki-shi Kanagawa (JP)

(21) Appl. No.: 19/451,490

(22) Filed: Jan. 16, 2026

(30) Foreign Application Priority Data
Jan. 31, 2025 (JP) 2025-014900

(51) Int. Cl. C25B 9/23; C25B 1/04; C25B 9/05; C25B 11/032; C25B 11/037; C25B 11/063; C25B 11/097

(52) U.S. Cl. CPC C25B 9/23; C25B 1/04; C25B 9/05; C25B 11/032; C25B 11/037; C25B 11/063; C25B 11/097

(57) ABSTRACT

A membrane electrode assembly includes: an anode; a cathode; and an electrolyte membrane provided between the anode and cathode. The anode includes: a porous and conductive anode conductive transport layer; and an anode catalyst layer provided between the anode conductive transport layer and the electrolyte membrane. The anode catalyst layer includes first sheet layers and first gap layers, each first sheet layer and each first gap layer being alternately stacked. The cathode includes a porous and conductive cathode conductive transport layer, and a cathode catalyst layer provided between the cathode conductive transport layer and the electrolyte membrane. The cathode catalyst layer includes second sheet layers and second gap layers, each second sheet layer and each second gap layer being alternately stacked. A porosity of the cathode conductive transport layer is higher than a porosity of the anode conductive transport layer.

### CROSS-REFERENCE TO RELATED APPLICATIONS

This application is based upon and claims the benefit of priority from Japanese Patent Application No. 2025-014900, filed on Jan. 31, 2025; the entire contents of which are incorporated herein by reference.

### FIELD

Embodiments relate to a membrane electrode assembly, an electrochemical cell, and a hydrogen production device.

### BACKGROUND

In recent years, development has progressed on electrochemical reaction devices such as water electrolysis devices (hydrogen production devices) that convert water into oxygen and hydrogen. The hydrogen production device, for example, includes a membrane electrode assembly (MEA) including an anode, a cathode, and an electrolyte membrane.

The hydrogen production device, for example, oxidizes water at the anode to produce hydrogen ions and oxygen, and reduces hydrogen ions at the cathode to produce hydrogen.

### BRIEF DESCRIPTION OF THE DRAWINGS

FIG. 1 is a schematic diagram illustrating an example structure of a membrane electrode assembly.

FIG. 2 is a cross-sectional schematic diagram illustrating an example structure of an electrode 10.

FIG. 3 is a schematic diagram illustrating a cross-sectional structure of a part of a catalyst layer 12.

FIG. 4 is a cross-sectional schematic diagram for explaining an example of a method for forming the catalyst layer 12.

FIG. 5 is a cross-sectional schematic diagram illustrating an example structure of an electrode 20.

FIG. 6 is a schematic diagram illustrating a cross-sectional structure of a part of a catalyst layer 22.

FIG. 7 is a cross-sectional schematic diagram for explaining an example of a method for forming the catalyst layer 22.

FIG. 8 is a schematic diagram illustrating an example configuration of a hydrogen production device.

### DETAILED DESCRIPTION

A membrane electrode assembly according to an embodiment includes an anode, a cathode, and an electrolyte membrane provided between the anode and the cathode. The anode includes an anode conductive transport layer that is porous and conductive, and an anode catalyst layer that is provided between the anode conductive transport layer and the electrolyte membrane. The anode catalyst layer includes first sheet layers and first gap layers, each first sheet layer and each first gap layer being alternately stacked. The cathode includes a cathode conductive transport layer that is porous and conductive, and a cathode catalyst layer that is provided between the cathode conductive transport layer and the electrolyte membrane. The cathode catalyst layer includes second sheet layers and second gap layers, each second sheet layer and each second gap layer being alternately stacked. A porosity of the cathode conductive transport layer is higher than a porosity of the anode conductive transport layer.

Embodiments will be explained below with reference to the drawings. In each embodiment, substantially the same components are denoted by the same reference signs, and the explanation thereof will be partially omitted in some cases. The drawings are schematic, in which the relationship between the thickness and planar dimensions, a thickness ratio among the components, and so on may be different from actual ones.

In this specification, “connection” includes not only direct connection but also indirect connection, unless otherwise specified.

### First Embodiment

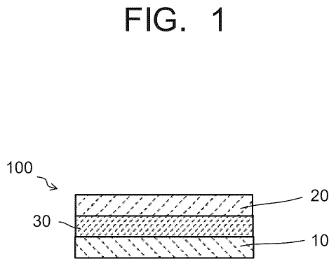

This embodiment describes an example of a membrane electrode assembly. FIG. 1 is a schematic diagram illustrating an example structure of the membrane electrode assembly. FIG. 1 illustrates a membrane electrode assembly 100.

The membrane electrode assembly 100 includes an electrode 10, an electrode 20, and an electrolyte membrane 30. The electrode 10, the electrode 20, and the electrolyte membrane 30 may be stacked together.

The electrode 10 functions as an anode. The electrode 10 may, for example, be an anode in a hydrogen production device or in other electrolysis devices, such as an ammonia electrolysis device.

The electrode 20 functions as a cathode. The electrode 20 may be, for example, a cathode in a hydrogen production device or in other electrolysis devices such as an ammonia electrolysis device.

The electrolyte membrane 30 is provided between the electrode 10 and the electrode 20.

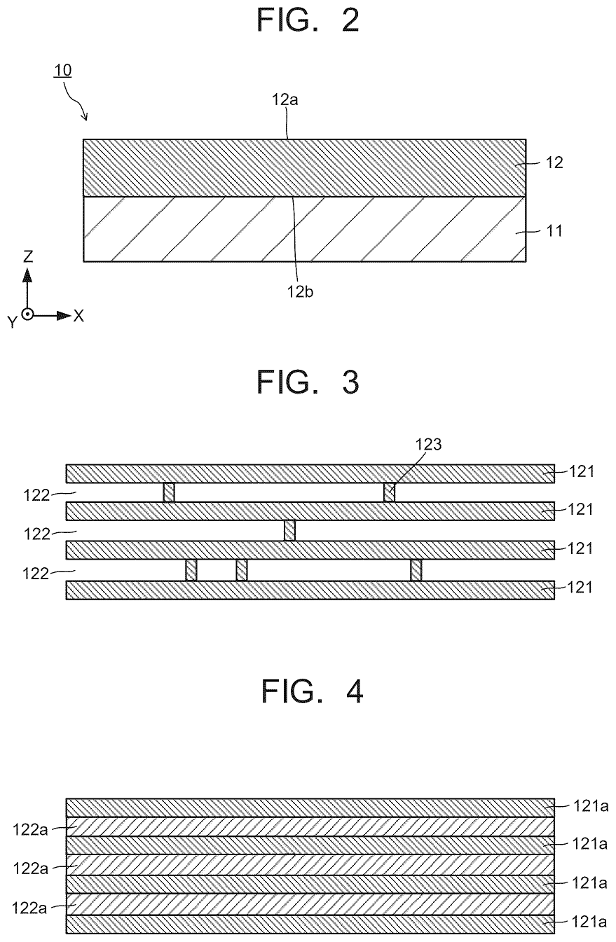

FIG. 2 is a cross-sectional schematic diagram illustrating an example structure of the electrode 10. FIG. 2 illustrates an X-axis, a Y-axis perpendicular to the X-axis, and a Z-axis perpendicular to both the X-axis and the Y-axis. FIG. 2 illustrates a part of an X-Z cross-section of the electrode 10. The Z-axis direction corresponds to a thickness direction of the electrode 10.

The electrode 10 includes a conductive transport layer 11 and a catalyst layer 12.

The conductive transport layer 11 is a porous and conductive anode conductive transport layer. Examples of the conductive transport layer 11 include substrates formed using carbon materials such as carbon cloth and carbon paper, metal materials such as titanium (Ti), nickel (Ni), and iron (Fe) or alloys containing at least one of these metals (for example, SUS). The conductive transport layer 11 may also be a nonwoven fabric, mesh substrate, or porous substrate having these materials. Examples of the porous substrate include a porous titanium material. The porous titanium material is suitable for the conductive transport layer 11 due to its high conductivity and high durability. Examples of the porous titanium material include a titanium mesh, a cloth made of titanium fibers, and a titanium sintered body.

When considering mass transfer, a porosity of the conductive transport layer 11 is preferably 20% or more and 95% or less, and more preferably 40% or more and 90% or less. For example, when the conductive transport layer 11 is a particle sintered body, a particle diameter is preferably 1 μm or more and 500 μm or less, and more preferably 1 μm or more and 100 μm or less, considering reactivity and electrical conductivity.

The conductive transport layer 11 may have a coating layer on its surface. A dense coating layer with conductivity can improve the durability of the electrode 10. The coating layer is not limited, but materials such as metal materials, ceramic materials like oxides and nitrides, and carbon can be used. In the coating layer, a multilayer structure or gradient structure made by different materials can be formed to further enhance the durability.

The catalyst layer 12 is an anode catalyst layer. The catalyst layer 12 is provided between the conductive transport layer 11 and the electrolyte membrane 30. The catalyst layer 12 is provided on the conductive transport layer 11 and includes a surface 12a provided on an opposite side of the conductive transport layer 11 and a surface 12b provided on an opposite side of the surface 12a and facing the conductive transport layer 11. The surface 12a may, for example, face the electrolyte membrane 30. FIG. 3 is a schematic diagram illustrating a cross-sectional structure of a part of the catalyst layer 12. The catalyst layer 12 has a stacked structure including sheet layers 121 and gap layers 122. FIG. 3 illustrates a plurality of sheet layers 121 and a plurality of gap layers 122. Each of the plurality of sheet layers 121 and each of the plurality of gap layers 122 are alternately stacked on the conductive transport layer 11. The plurality of sheet layers 121 may have their ends partially bonded together in at least one direction, either the X-axis direction or the Y-axis direction. This suppresses deformation of the catalyst layer 12 due to a pressure in a stacking direction. The catalyst layer 12 may also include catalyst pillars 123 connecting the plurality of sheet layers 121 between them. This suppresses peeling of the sheet layers 121.

The sheet layer 121 and the catalyst pillar 123 possess an anode catalyst that promotes oxidation of oxidisable materials. The number of stacked sheet layers 121 is not limited, but is, for example, 5 layers or more and 20 layers or less. A thickness of the sheet layer 121 is, for example, 4 nm or more and 50 nm or less.

Examples of the anode catalyst include a noble metal oxide whose main component is iridium (Ir) or ruthenium (Ru). Here, the main component refers to the component that has the highest concentration among constituents. Examples of the noble metal oxides include iridium oxide and ruthenium oxide. In water electrolysis devices, the anode catalyst is a material that promotes a reaction of, for example, oxidizing water to produce oxygen and hydrogen ions.

The gap layer 122 is provided between the plurality of sheet layers 121. The gap layer 122 forms a space between the plurality of sheet layers 121. An average thickness of the gap layers 122 is, for example, 1 nm or more and 100 nm or less.

An average thickness of the catalyst layer 12 is, for example, 10 nm or more and 900 nm or less. When the average thickness is less than 10 nm, a catalytic amount is insufficient, and reaction efficiency decreases. When it exceeds 900 nm, diffusibility deteriorates, which worsens the performance of water supply to the catalyst layer and oxygen gas discharge, leading to performance degradation.

Dimensions and composition of the conductive transport layer 11, catalyst layer 12, sheet layer 121, and gap layer 122 can be measured using, for example, a scanning electron microscope (SEM), an X-ray fluorescence analysis (XRF), elemental mapping by a transmission electron microscope (TEM), TEM high-angle annular dark-field (HAADF), and energy dispersive X-ray spectroscopy (EDX).

FIG. 4 is a cross-sectional schematic diagram for explaining an example of a method for forming the catalyst layer 12. As illustrated in FIG. 4, the catalyst layer 12 can be formed by alternately forming a precursor layer 121a of the sheet layer 121 and a pore-forming material layer 122a onto the conductive transport layer 11 using sputtering, and then removing the pore-forming material layer 122a while leaving the precursor layer 121a. This method enables nanometer-level thickness control of both the sheet layer 121 and the pore-forming material layer 122a, and further facilitates control of the composition and oxidation state, thereby enhancing the design flexibility of the sheet layer 121.

The precursor layer 121a includes an anode catalyst. When the precursor layer 121a is amorphous, a crystal structure may be oriented by performing heat treatment. When a catalyst containing iridium oxide is used, reactive sputtering with oxygen gas added to the sputtering apparatus chamber is preferred.

The pore-forming material layer 122a contains a pore-forming material. Examples of the pore-forming material include at least one non-noble metal or oxide thereof. Examples of the non-noble metal include iron (Fe), cobalt (Co), nickel (Ni), manganese (Mn), aluminum (Al), zinc (Zn), tantalum (Ta), tungsten (W), hafnium (Hf), silicon (Si), molybdenum (Mo), titanium (Ti), zirconium (Zr), niobium (Nb), vanadium (V), chromium (Cr), tin (Sn), and strontium (Sr). Further, the pore-forming material layers 122a can be removed by selective etching using chemicals such as acid or alkali, for example, while leaving the catalyst layers 121. Heat treatment may be performed to promote melting of the pore-forming material layers 122a.

The pore-forming material may also be contained in the precursor layer 121a. The precursor layer 121a containing the pore-forming material can be formed by performing sputtering using a mixed sputtering target containing a raw material of the precursor layer 121a and a raw material of the pore-forming material, for example. Thereby, the pore-forming material in the precursor layer 121a is also removed by selective etching, to make the sheet layer 121 porous. Therefore, a surface area of the sheet layer 121 can be increased.

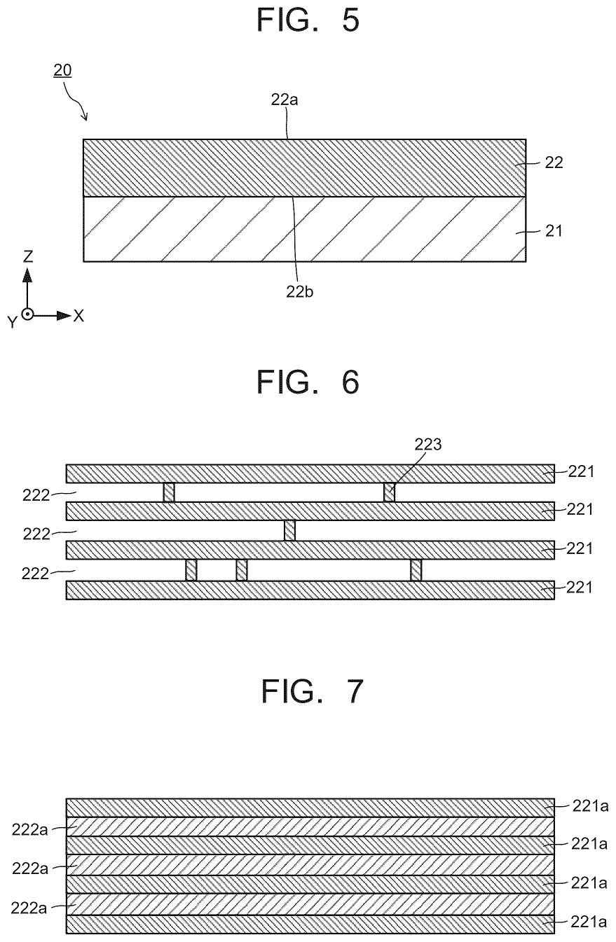

FIG. 5 is a cross-sectional schematic diagram illustrating an example structure of the electrode 20. FIG. 5 illustrates an X-axis, a Y-axis perpendicular to the X-axis, and a Z-axis perpendicular to both the X-axis and the Y-axis. FIG. 5 illustrates a part of an X-Z cross-section of the electrode 20. The Z-axis direction corresponds to a thickness direction of the electrode 20.

The electrode 20 includes a conductive transport layer 21 and a catalyst layer 22.

The conductive transport layer 21 is a porous and conductive cathode conductive transport layer. Examples of the conductive transport layer 21 include substrates formed using carbon materials such as carbon cloth and carbon paper, metal materials such as titanium (Ti), nickel (Ni), and iron (Fe) or alloys containing at least one of these metals (for example, SUS). The conductive transport layer 21 may also be a nonwoven fabric, mesh substrate, or porous substrate having these materials. Examples of the porous substrate include a porous titanium material. The porous titanium material is suitable for the conductive transport layer 21 due to its high conductivity and high durability. Examples of the porous titanium material include a titanium mesh, a cloth made of titanium fibers, and a titanium sintered body.

When considering mass transfer, a porosity of the conductive transport layer 21 is preferably 20% or more and 95% or less, and more preferably 40% or more and 90% or less. For example, when the conductive transport layer 21 is a metal nonwoven fabric formed by entangling metal fibers, a fiber diameter is preferably 1 μm or more and 500 μm or less. The fiber diameter of the conductive transport layer 21 is preferably larger than the particle diameter of the conductive transport layer 11.

The conductive transport layer 21 may have a coating layer on its surface. A dense coating layer with conductivity can improve the durability of the electrode 20. The coating layer is not limited, but metal materials, ceramic materials such as oxides and nitrides, carbon, and the like can be used. In the coating layer, a multilayer structure or gradient structure made by different materials can be formed to further enhance durability.

The catalyst layer 22 is a cathode catalyst layer. The catalyst layer 22 is provided between the conductive transport layer 21 and the electrolyte membrane 30. The catalyst layer 22 is provided on the conductive transport layer 21 and includes a surface 22a provided on an opposite side of the conductive transport layer 21 and a surface 22b provided on an opposite side of the surface 22a and facing the conductive transport layer 21. The surface 22a may, for example, face the electrolyte membrane 30. FIG. 6 is a schematic diagram illustrating a cross-sectional structure of a part of the catalyst layer 22. The catalyst layer 22 has a stacked structure including sheet layers 221 and gap layers 222. FIG. 6 illustrates a plurality of sheet layers 221 and a plurality of gap layers 222. Each of the plurality of sheet layers 221 and each of the plurality of gap layers 222 are alternately stacked on the conductive transport layer 21. The plurality of sheet layers 221 may have their ends partially bonded together in at least one direction, either the X-axis direction or the Y-axis direction. This suppresses deformation of the catalyst layer 22 due to a pressure in a stacking direction. The catalyst layer 22 may also include catalyst pillars 223 connecting the plurality of sheet layers 221 between them. This suppresses peeling of the sheet layers 221.

The sheet layer 221 and the catalyst pillar 223 possess a cathode catalyst that promotes reduction of reducible materials. The number of stacked sheet layers 221 is not limited, but is, for example, 5 layers or more and 20 layers or less. A thickness of the sheet layer 221 is, for example, 4 nm or more and 50 nm or less.

Examples of the cathode catalyst include a noble metal oxide whose main component is platinum (Pt). Here, the main component refers to the component that has the highest concentration among constituents. Examples of the noble metal oxides include platinum oxide. In water electrolysis devices, the cathode catalyst is a material that promotes a reaction of, for example, reducing hydrogen ions to produce hydrogen.

The gap layer 222 is provided between the plurality of sheet layers 221. The gap layer 222 forms a space between the plurality of sheet layers 221. An average thickness of the gap layers 222 is, for example, 1 nm or more and 100 nm or less.

An average thickness of the catalyst layer 22 is, for example, 10 nm or more and 900 nm or less. When the average thickness is less than 10 nm, a catalytic amount is insufficient, and reaction efficiency decreases. When it exceeds 900 nm, diffusibility deteriorates, which worsens the performance of water supply to the catalyst layer and oxygen gas discharge, leading to performance degradation.

Dimensions and composition of the conductive transport layer 21, catalyst layer 22, sheet layer 221, and gap layer 222 can be measured using, for example, a scanning electron microscope (SEM), an X-ray fluorescence analysis (XRF), elemental mapping by a transmission electron microscope (TEM), TEM high-angle annular dark-field (HAADF), and energy dispersive X-ray spectroscopy (EDX).

FIG. 7 is a cross-sectional schematic diagram for explaining an example of a method for forming the catalyst layer 22. As illustrated in FIG. 7, the catalyst layer 22 can be formed by alternately forming a precursor layer 221a of the sheet layer 221 and a pore-forming material layer 222a onto the conductive transport layer 21 using sputtering, and then removing the pore-forming material layer 222a while leaving the precursor layer 221a. This method enables nanometer-level thickness control of both the sheet layer 221 and the pore-forming material layer 222a, and further facilitates control of the composition and oxidation state, thereby enhancing the design flexibility of the sheet layer 221.

The precursor layer 221a includes a cathode catalyst. When the precursor layer 221a is amorphous, a crystal structure may be oriented by performing heat treatment.

The pore-forming material layer 222a contains a pore-forming material. Examples of the pore-forming material include at least one non-noble metal or oxide thereof.

Examples of the non-noble metal include iron (Fe), cobalt (Co), nickel (Ni), manganese (Mn), aluminum (Al), zinc (Zn), tantalum (Ta), tungsten (W), hafnium (Hf), silicon (Si), molybdenum (Mo), titanium (Ti), zirconium (Zr), niobium (Nb), vanadium (V), chromium (Cr), tin (Sn), and strontium (Sr). Further, the pore-forming material layers 222a can be removed by selective etching using chemicals such as acid or alkali, for example, while leaving the sheet layers 221. Heat treatment may be performed to promote melting of the pore-forming material layers 222a.

The pore-forming material may also be contained in the precursor layer 221a. The precursor layer 221a containing the pore-forming material can be formed by performing sputtering using a mixed sputtering target containing a raw material of the precursor layer 221a and a raw material of the pore-forming material, for example. Thereby, the pore-forming material in the precursor layer 221a is also removed by selective etching, to make the sheet layer 221 porous. Therefore, a surface area of the sheet layer 221 can be increased.

The electrolyte membrane 30 is formed by, for example, an ion exchange membrane or the like that can move ions between the electrode 10 and the electrode 20. A cation-exchange membrane, such as, for example, Nafion or Flemion, may be used as the ion exchange membrane. A part of the catalyst layer 12 or a part of the catalyst layer 22 may be impregnated into the electrolyte membrane 30.

When forming the catalyst layer 22 by coating a mixture of cathode catalyst powder and ionomer onto a gas diffusion layer without using sputtering, problems arise under high-pressure conditions, such as when the pressure in a cathode flow path facing the cathode is 2026500 Pa (20 atmospheres) or higher, for example, where liquids such as water and gas such as hydrogen are difficult to discharge from the cathode. Furthermore, during operation of an electrochemical cell, peeling between the catalyst layer 22 and the electrolyte membrane 30 is likely to occur. These issues cause cell performance degradation, such as an increase in cell voltage.

In contrast, in the membrane electrode assembly 100 of this embodiment, since the catalyst layer 22 is formed as the stacked structure of the sheet layers and the gap layers, a part of the catalyst layer 22 can be embedded into the electrolyte membrane 30, for example, to thereby suppress the peeling between the catalyst layer 22 and the electrolyte membrane 30. Besides, it allows for an increase in the surface area of the catalyst layer 22.

Furthermore, compared to forming the catalyst layer 22 by coating the mixture of the cathode catalyst powder and ionomer onto the gas diffusion layer, an effective amount of cathode catalyst can be increased. These features suppress cell performance degradation.

A porosity of the conductive transport layer 21 is preferably higher than that of the conductive transport layer 11. This facilitates the movement of liquids, such as water, and gas, such as hydrogen, on the electrode 20 side, thereby suppressing cell performance degradation. The porosity can be measured, for example, by a mercury intrusion method.

### Second Embodiment

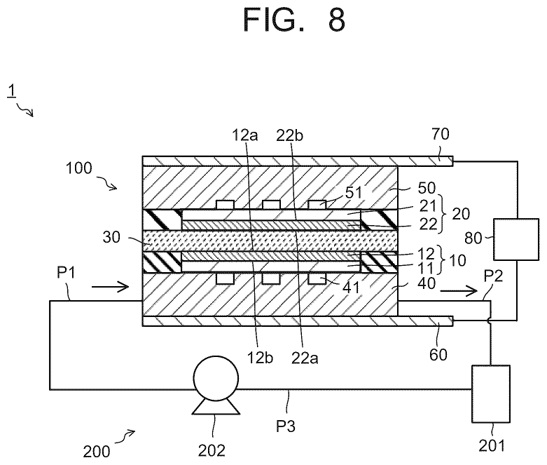

This embodiment describes an example of a hydrogen production device having the membrane electrode assembly according to the first embodiment. FIG. 8 is a schematic diagram illustrating an example configuration of the hydrogen production device. A hydrogen production device 1 illustrated in FIG. 8 includes the membrane electrode assembly 100 and an anode solution supply system 200.

The conductive transport layer 11 is provided facing an anode flow path 41 through which an anode solution flows. The electrode 10 is provided such that the surface 12b of the catalyst layer 12 faces the conductive transport layer 11, and the surface 12a faces the electrolyte membrane 30. The anode flow path 41 has a groove formed on a surface of a separator 40. The anode flow path 41 has an inlet and an outlet, which are not illustrated. The inlet of the anode flow path 41 is connected to an anode supply flow path P1. The outlet of the anode flow path 41 is connected to an anode discharge flow path P2. A shape of the anode flow path 41 is not limited, but may, for example, have a serpentine shape along the surface of the separator 40. The separator 40 functions as an anode flow path plate. The separator 40 is, for example, made of metal.

The conductive transport layer 21 is provided facing a cathode flow path 51. The electrode 20 is provided such that the surface 22b of the catalyst layer 22 faces the conductive transport layer 21, and the surface 22a faces the electrolyte membrane 30. The cathode flow path 51 has a groove formed on a surface of a separator 50. The cathode flow path 51 has a not-illustrated outlet. The outlet of the cathode flow path 51 is connected, for example, to a not-illustrated product collector. A shape of the cathode flow path 51 is not limited, but may, for example, have a serpentine shape along the surface of the separator 50. The separator 50 functions as a cathode flow path plate. The separator 50 is, for example, made of metal.

The electrodes 10 and 20 are electrically connected to an anode current collector 60 and a cathode current collector 70, respectively. The anode current collector 60 and the cathode current collector 70 are electrically connected to a power supply 80 via current introduction members. The power supply 80 is not limited to power sources such as a normal grid power supply or a battery, and may have a power source that supplies electric power generated by renewable energy, such as a solar cell or wind power generation. The power supply 80 may include the aforementioned power source and a power controller or the like that adjusts the output of the aforementioned power source to control the voltage between the electrode 10 and the electrode 20.

The electrode 10, the electrode 20, the electrolyte membrane 30, the separator 40, the separator 50, the anode current collector 60, and the cathode current collector 70 may be stacked together. This stack is also referred to as an electrochemical cell. The membrane electrode assembly 100 is sandwiched between the separator 40 and the separator 50. The stack may be sandwiched between a pair of support plates, which are not illustrated, and further fastened with bolts or the like.

The anode solution supply system 200 includes an anode solution container 201, a flow rate controller 202, and a circulation flow path P3, and is configured such that the anode solution circulates through the anode flow path 41. The anode solution supply system 200 connects the anode supply flow path P1 and the anode discharge flow path P2 via the circulation flow path P3. Valves or pumps may be formed in the middle of the anode supply flow path P1, the anode discharge flow path P2, or the circulation flow path P3 to control a pressure in each flow path or a flow rate of fluid flowing through each flow path.

The anode solution container 201 has a tank that stores fluid containing the anode solution discharged from the outlet of the anode flow path 41 via the anode discharge flow path P2 (also called anode waste liquid). The flow rate controller 202 is provided in the middle of at least one of the anode supply flow path P1, the anode discharge flow path P2, and the circulation flow path P3, and controls the flow rate of the anode solution. The anode solution is introduced into the anode flow path 41 via the anode supply flow path P1. A pressure controller may be provided in the middle of at least one of the anode supply flow path P1, the anode discharge flow path P2, and the circulation flow path P3 to control a pressure of the anode flow path 41. The anode solution container 201 may be connected to a not-illustrated anode solution supply source, and the anode solution container 201 may be replenished with the anode solution from the anode solution supply source.

The anode solution is preferably a solution containing at least water (H₂O). The anode solution may be, for example, ultrapure water. The anode solution may contain nickel ions.

Next, a control method of an electrochemical reaction device will be explained.

When performing electrolysis using the electrochemical reaction device, an anode solution is supplied to the anode flow path 41, and the power supply 80 applies the voltage between the electrode 10 and the electrode 20 to supply current. The anode solution is supplied to the gap layers 122 of the electrode 10. When the current is applied between the electrode 10 and the electrode 20, an oxidation reaction near the electrode 10 and a reduction reaction near the electrode 20 occur as described below. The case where water is oxidized to produce hydrogen ions and the hydrogen ions are reduced to produce hydrogen is explained here, but other side reactions may also occur.

First, a reaction process in the case where water (H₂O) is oxidized to produce hydrogen ions (H⁺) is explained. When the power supply 80 supplies the current between the electrode 10 and the electrode 20, the oxidation reaction of water (H2O) occurs at the electrode 10 in contact with the anode solution. Concretely, as expressed in (1) Formula below, H₂O contained in the anode solution is oxidized to produce oxygen (O₂), hydrogen ions (H⁺), and electrons (e⁻). The oxygen produced at the electrode 10 is discharged to the outside of the electrode 10 through the gap layers 122. The discharged oxygen may be collected by a not-illustrated anode product collector.

2H₂O—4H⁺+O₂+4e⁻ (1)

H⁺ produced at the electrode 10 moves through the anode solution present in the electrode 10 and the electrolyte membrane 30 and reaches the vicinity of the electrode 20. The electrons (e⁻) based on the current supplied from the power supply 80 to the electrode 20, and H⁺that have moved to the vicinity of the electrode 20 cause the reduction reaction of the hydrogen ions. Concretely, as expressed in (2) Formula below, the hydrogen ions are reduced to produce hydrogen. The hydrogen produced at the electrode 20 is discharged from the outlet of the cathode flow path 51. The discharged hydrogen may be collected by a not-illustrated cathode product collector.

4H⁺+4e⁻→2H₂ (2)

During operation of the electrochemical cell, it is preferable that a pressure applied to the cathode flow path 51 be higher than the pressure applied to the anode flow path 41. This enables efficient hydrogen storage. The pressure in the cathode flow path 51 and the pressure in the anode flow path 41 may be controlled by adjusting the flow rate of each fluid.

The above is the explanation of the control method of the electrochemical reaction device. In the electrochemical reaction device in this embodiment, applying the membrane electrode assembly 100 in the first embodiment to the electrode 10 suppresses the performance degradation of the electrochemical reaction device.

EXAMPLES

### Example 1

A hydrogen production device having the configuration illustrated in FIG. 8 was manufactured. As for the electrode 10, the sheet layers 121 and the gap layers 122 were formed by sputtering Ir and Ni alternately on a titanium particle sheet serving as the conductive transport layer 11 and etching Ni with acid. A thickness of the sheet layer 121 was 30 nm. A thickness of the catalyst layer 12 was 350 nm. The number of stacked sheet layers 121 was 10. As for the electrode 20, the sheet layers 221 and the gap layers 222 were formed by sputtering Pt and Ni alternately onto a titanium nonwoven fabric serving as the conductive transport layer 21, and etching Ni with acid. A thickness of the sheet layer 221 was 20 nm. A thickness of the catalyst layer 22 was 250 nm. The number of stacked sheet layers 221 was five. A porosity of the conductive transport layer 21 was higher than that of the conductive transport layer 11. The electrolyte membrane 30 was Nafion. The separators 40 and 50 were formed by machining titanium. The anode current collector 60 and the cathode current collector 70 were formed by gold plating titanium plates. These members were stacked, sandwiched between support plates, which were not illustrated, and further fastened with bolts.

In the hydrogen production device in Example 1, the pressure applied to the cathode flow path 51 was set higher than the pressure applied to the anode flow path 41, the temperature of the electrochemical cell was set to 80 °C, and an electrolysis operation was continuously performed at a current density of 2 A/cm² while supplying water to the anode. The voltage between the electrode 10 and the electrode 20 (the voltage of the electrochemical cell) was measured 48 hours after the start of the electrolysis operation, and found to be 1.782 V.

### Comparative Example 1

A hydrogen production device was manufactured in the same manner as Example 1, except for forming the electrode 20 by a spray method, that is, spraying a catalyst slurry onto the conductive transport layer 21, drying it, and forming the catalyst layer 22 on the conductive transport layer 21. The voltage of the electrochemical cell was measured and found to be 1.850 V.

The comparison results between Example 1 and Comparative Example 1 show that using a cathode catalyst layer with the stacked structure of the sheet layers and the gap layers enables a lower voltage in the electrochemical cell.

Note that the configurations of the above-described embodiments are applicable in combination. Further, parts thereof are replaceable. While certain embodiments of the present invention have been described above, these embodiments have been presented by way of example only and are not intended to limit the scope of the invention. Indeed, the embodiments described herein may be embodied in a variety of other forms; furthermore, various omissions, substitutions, and changes in the form of the embodiments described herein may be made without departing from the spirit of the inventions. The accompanying claims and their equivalents are intended to cover such embodiments or modifications as would fall within the scope and spirit of the inventions.

The above-described embodiments can be summarized into the following Clauses.

### Clause 1

A membrane electrode assembly including:
an anode;
a cathode; and
an electrolyte membrane that is provided between the anode and the cathode, wherein
the anode includes:
   an anode conductive transport layer that is porous and conductive; and
   an anode catalyst layer that is provided between the anode conductive transport layer and the electrolyte membrane, wherein
   the anode catalyst layer includes first sheet layers and first gap layers, each first sheet layer and each first gap layer being alternately stacked, and
the cathode includes:
   a cathode conductive transport layer that is porous and conductive, and
   a cathode catalyst layer that is provided between the cathode conductive transport layer and the electrolyte membrane, wherein
   the cathode catalyst layer includes second sheet layers and second gap layers, each second sheet layer and each second gap layer being alternately stacked, and wherein
a porosity of the cathode conductive transport layer is higher than a porosity of the anode conductive transport layer.

### Clause 2

The membrane electrode assembly according to Clause 1, wherein
the first sheet layer contains iridium, and
the second sheet layer contains platinum.

### Clause 3

The membrane electrode assembly according to Clause 1 or Clause 2, wherein
the cathode conductive transport layer contains titanium.

### Clause 4

The membrane electrode assembly according to any one of Clauses 1 to 3, wherein
the anode conductive transport layer has particles, and
the cathode conductive transport layer has fibers.

### Clause 5

An electrochemical cell, including:
the membrane electrode assembly according to any one of Clauses 1 to 4, and
a pair of separators that sandwich the membrane electrode assembly.

### Clause 6

The electrochemical cell according to Clause 5, wherein
during operation of the electrochemical cell, a pressure applied to a cathode flow path facing the cathode is higher than a pressure applied to an anode flow path facing the anode.

### Clause 7

A hydrogen production device, including:
the electrochemical cell according to Clause 5.

What is claimed is:

1. A membrane electrode assembly comprising:
an anode;
a cathode; and
an electrolyte membrane that is provided between the anode and the cathode, wherein the anode includes:
an anode conductive transport layer that is porous and conductive; and
an anode catalyst layer that is provided between the anode conductive transport layer and the electrolyte membrane, wherein the anode catalyst layer includes first sheet layers and first gap layers, each first sheet layer and each first gap layer being alternately stacked, and the cathode includes:
a cathode conductive transport layer that is porous and conductive, and a cathode catalyst layer that is provided between the cathode conductive transport layer and the electrolyte membrane, wherein the cathode catalyst layer includes second sheet layers and second gap layers, each second sheet layer and each second gap layer being alternately stacked, and wherein a porosity of the cathode conductive transport layer is higher than a porosity of the anode conductive transport layer.

2. The membrane electrode assembly according to claim 1, wherein the first sheet layer contains iridium, and the second sheet layer contains platinum.

3. The membrane electrode assembly according to claim 1, wherein the cathode conductive transport layer contains titanium.

4. The membrane electrode assembly according to claim 1, wherein the anode conductive transport layer has particles, and the cathode conductive transport layer has fibers.

5. An electrochemical cell comprising:
the membrane electrode assembly according to claim 1, and a pair of separators that sandwich the membrane electrode assembly.

6. The electrochemical cell according to claim 5, wherein during operation of the electrochemical cell, a pressure applied to a cathode flow path facing the cathode is higher than a pressure applied to an anode flow path facing the anode.

7. A hydrogen production device comprising:
the electrochemical cell according to claim 5.
